(19) United States
(12) Patent Application Publication
(10) Pub. No.: US 2004/0091122 A1
(43) Pub. Date: May 13, 2004

(54) Communications system

(76) Inventors: Dan Bavholm, Kullavik (SE); Klas Dalbjorn, Billdal (SE); Kenneth Andersson, Kungsbacka (SE)

Correspondence Address: YOUNG & THOMPSON, 745 SOUTH 23RD STREET 2ND FLOOR, ARLINGTON, VA, 22202

(21) Appl. No.: 10/471,005

(22) PCT Filed: Mar. 7, 2002
(86) PCT No.: PCT/SE02/00411

(30) Foreign Application Priority Data
Mar. 7, 2001 (SE) 0100770-7

(51) Int. Cl. H04B 3/00; H04R 27/00

(52) U.S. Cl. 381/80; 381/82; 381/77

(57) ABSTRACT

A first local controller (30) having a device port coupled to a device control port for communicating with a device to be monitored or controlled, a primary local port for coupling to a first interface port (90) of an interface unit, and a secondary local port.

### TECHNICAL FIELD OF THE INVENTION

The present invention relates to a communications system and a method of operating a communications system. The invention also relates to a local controller and to a method of operating such a controller. Moreover, the invention relates to a computer program for performing the method. The invention also relates to an audio system and to a method of setting up an audio system.

### DESCRIPTION OF RELATED ART

In many areas it is necessary to monitor and/or control a number of devices or nodes from a central monitoring/control computer. One such area is the area of audio systems for use in studios, and public halls, or for use in connection with concerts by musicians or bands on tour. In connection with such a concert the touring musicians often bring their own audio devices including for example amplifiers, loudspeakers, microphones and instruments connectable to the amplifiers as well as equipment for monitoring and controlling the audio devices.

U.S. Pat. No. 5,406,634 discloses a speaker system network including a control computer having a control board including a number of audio inputs. Some audio inputs are analogue inputs connected to analogue-to-digital converters whose outputs are connected to a multiplexing circuit, and some audio inputs are digital inputs connected directly to the multiplexing circuit. The output of the multiplexing circuit is connected to a digital audio control and data bus via a transmitter. A number of intelligent speaker units are attached to the digital audio control and data bus to receive the transmitted audio data and control data from the transmitter. Each of the speaker units has a Digital Signal Processor for processing the audio data in accordance with the control data. The control data contains an address to select the speaker unit and each of the speaker units has an address, which is set by a DIPswitch. The DIP switches are used so that an operator, when replacing a speaker unit, can set the address of the replacement unit to the same address as the replaced unit.

### SUMMARY

An aspect of the invention relates to the problem of providing a communications system allowing an uncomplicated and reliable set-up procedure.

This problem is addressed by the solutions according to the appended claims.

An additional object of the present invention is to achieve a system that is easy to expand by adding, replacing or removing controllable devices and corresponding device controllers. This problem is adressed by providing communications devices capable of communicating in an orderly manner even without being provided with individual adresses.

### BRIEF DESCRIPTION OF THE DRAWINGS

For simple understanding of the present invention, it will be described by means of examples and with reference to the accompanying table 1 and the drawings, of which

FIG. 1 shows a schematic block diagram of a first embodiment of an audio system.

FIGS. 2-6 are described below.

FIG. 7 is a schematic representation of an embodiment of a local controller 30 and a corresponding device 20.

FIGS. 8, 9 and 10 illustrate embodiments of communications circuits 300 functioning as described in connection with FIG. 3

FIG. 11 illustrates an example of the transmission characteristic of the circuitry, shown in FIGS. 3, 8, 9, and 10.

FIG. 12 is a schematic representation of an embodiment of the communications circuit 300.

### DETAILED DESCRIPTION OF EMBODIMENTS

In the following description similar features in different embodiments will be indicated by the same reference numerals.

An Embodiment of a Communications System

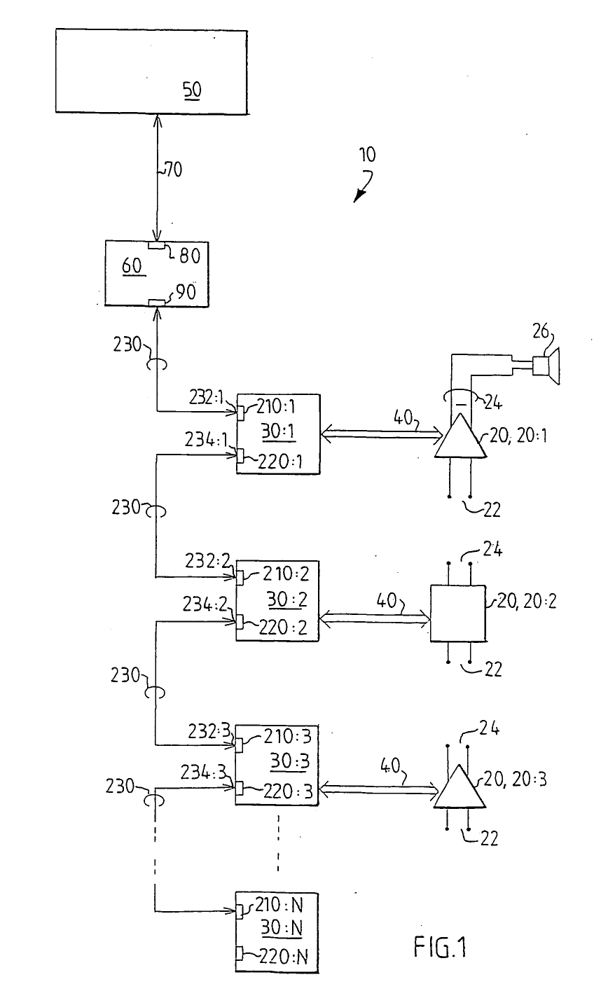

FIG. 1 shows a block diagram of an audio monitoring/control system 10 comprising a plurality of audio devices 20. Each audio device 20 is coupled to a local controller 30 via an application interface circuitry 40.

An audio device has an input port 22 for receiving an audio signal, such as for example a digital or analogue representation of the sound from a musical instrument or the vocals of singer. The audio device 20 also has an output port 24 for a delivering a resulting audio output signal. This audio output signal may be an analogue signal or a digital signal.

An audio device may be a digital or analogue amplifier 20:1 whose gain is controllable by means of a control signal sent to the audio device via the application interface circuitry 40. The output 24 may be coupled to a load such as a loud speaker 26, as illustrated in FIG. 1. Alternatively the output may be connected to another audio device for further signal treatment. When the output 24 delivers a digital signal this further signal treatment may be a digital signal treatment using digital circuitry. When, alternatively, the output 24 delivers an analogue signal this further signal treatment may be an analogue signal treatment using analogue circuitry.

An audio device may be controllable to perform other operations than gain control on an audio signal, such as for example expanding or compressing the dynamics of the audio signal, filtering the audio signal or gating the audio signal. The term gating of a signal includes suppressing the signal when the input signal is below a certain threshold value and amplifying it when the input signal is above a certain threshold value. The term filtering includes controllably achieving different amplification for different frequency components of the audio signal. An audio device may include a Digital Signal Processor (DSP) for performing the operations on the audio signal, as described above.

The audio control system 10 also comprises a user control device 50 having a user interface such as a display (not shown) for presentation of information to a user and keyboard (not shown) for entering information. The user control device 50 also includes a non-volatile memory, e.g. a hard disk, provided with control software, and a volatile memory. The user control device 50 may be embodied by a personal computer.

The user control device 50 is coupled to an interface unit 60 via a communications path 70. The communications path 70 may be comprise communication based on the Ethernet standard.

According to another embodiment there may be provided a plurality of user control devices 50 coupled to the communications path 70. One or several devices 50 may operate only to monitor the operation of the system 10, e.g. by receiving data transmitted by the apparatuses 30 and forwarded by the interface unit 60.

The interface unit 60 comprises a first interface port 80 for communication with said central controller 50, a second interface port 90; and means for communicating with the central controller 50, as well as means for delivering and receiving messages on said second interface port.

According to one version of the invention the interface unit 60 operates to transfer information in both directions between ports 80 and 90 while translating between the Ethernet communications standard used on port 80 and the communications standard used on port 90. A communications standard that can be used on port 90 will be described in further detail later in this document.

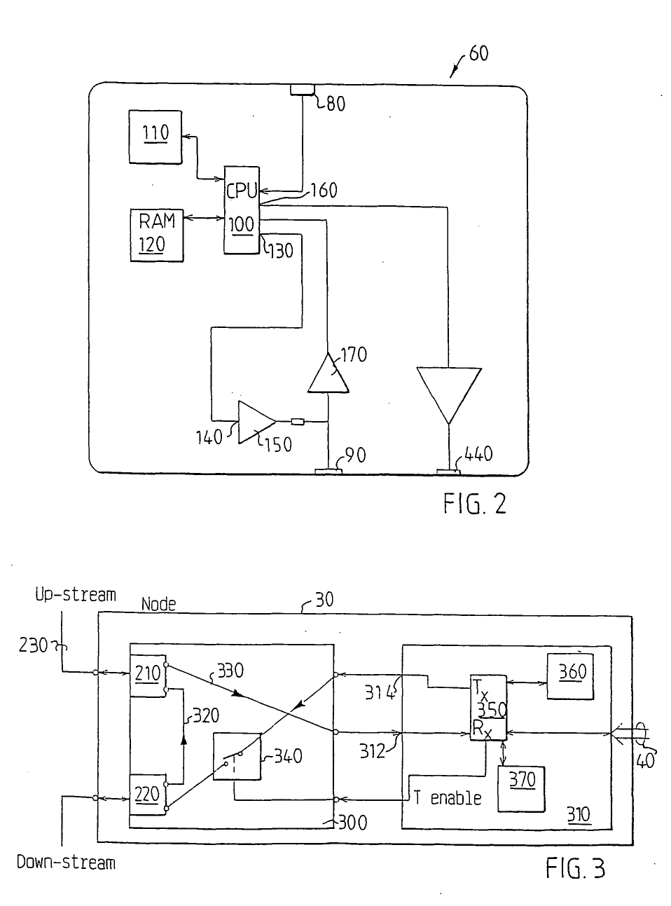

FIG. 2 is a block diagram of an embodiment of the interface unit 60. The interface unit 60 comprises a central processing unit 100, a non-volatile readable and writeable memory 110 and a volatile work memory 120. The work memory 120 may also be a readable and writeable non-volatile memory. Both memories 110, 120 are coupled to the central processing unit 100. The non-volatile memory 110, which may be a FLASH memory, is provided with a computer program for controlling the interface unit 60 to perform a number of functions. When, in this document, it is stated that the interface unit 60 performs a certain function it is to be interpreted to mean that execution of the program stored in the non-volatile memory 110 causes the interface unit 60 to perform that function.

The central processing unit 100 has an output 130 for serial communication. The serial output 130 is coupled to an input 140 of drive amplifier 150 for delivering a serial digital bit stream on the second interface port 90. A CPU input 160 for serial communication is coupled to an output of an amplifier 170, whose input is coupled to the second interface port 90. Hence, the interface unit 60 is capable of transmitting as well as receiving serial data on the port 90.

Therefore, the interface unit 60 is capable of interfacing the network of local controllers 30 to an existing network 70, e.g. operating according to the an Ethernet standard. The interface unit 60 may thereby function as a gateway allowing protocol translation, at any level up to the application level. It can also function as a proxy, storing in the memory 120 copies of controllable parameter values within each local controller 30 or audio device 20.

With reference to FIG. 1, the port 90 is coupled to a primary port 210:1 of a first local controller 30:1. The first local controller 30:1 has a secondary port 220:1 which is coupled to a primary port 210:2 of a second local controller 30:2.

The local controller 30:2 has a secondary port 220:2 which is coupled to the primary port 210:3 of the next local controller 30:3. In this manner a large number N of local controllers may be connected in a chain manner, as illustrated in FIG. 1.

According to an embodiment of the invention the coupling between the primary port 210 of a local controller 30:i and the secondary port 220 of the previous local controller 30:i−1 is achieved by means of a cable 230. The cables 230 have two ends, each end being provided with a connector. In order to eliminate or minimize the risk for erroneous interconnection of audio control system 10, each cable 230 has a primary connector 232 adapted to physically mate only with a primary port connector 210, and a secondary connector 234 adapted to physically mate only with a corresponding secondary port connector 220. Whereas two local controllers 30:i and 30:i−1, being adjacent to each other in terms of being interconnected by a certain cable 230, the distance between the local controllers may be anything from a few centimetres to several hundred meters.

FIG. 3 is a simplified block diagram intended to illustrate the function of the local controllers 30. A local controller 30 has a communication circuit 300 and an application circuit 310.

The application circuit 310 is concerned with the exchange of control and/or monitoring information with an audio device via the application interface circuitry 40. The application circuit also comprises a serial data reception port 312, and a serial data transmission port 314 for exchanging data with the communication circuit 300, as described below.

The communication circuit 300 comprises the above described primary port 210, which is connectable to a cable 230 for communicating with another local controller or with the second interface port 90 of interface unit 60, as described above. The communication circuit 300 also comprises the secondary communications port 220. The communications circuit 300 comprises circuitry 320 operating to detect data being received on the secondary communications port 220, the circuitry also operating to transfer such data to port 210. An arrow 320 in FIG. 3 illustrates this functionality.

The communications circuit 300 also comprises circuitry 330 operating to detect data being present on the primary port 210, said circuitry 330 also operating to deliver such data to the serial data reception port 312 of the application circuit 310.

Moreover, the communications circuit 300 comprises circuitry 340 operating to detect data being present on the serial data transmission port 314, said circuitry 340 also operating to deliver such data to the secondary communications port 220.

According to one embodiment the application circuit 310 comprises a non-volatile memory 360 and a processing unit 350 connected to the serial data transmission port 314 as well as to serial data reception port 312. The non-volatile memory 360, which may be a FLASH memory, is provided with a computer program for controlling the local controller 30 to perform a number of functions. When, in this document, it is stated that the local controller 30 performs a certain function it is to be interpreted to mean that execution of the program stored in the non-volatile memory 360 causes the local controller 30 to perform that function. The application circuit 310 also comprises a volatile work memory 370 being coupled to the central processing unit 350. The memory 360 may be readable and writeable. The work memory 370 may also be a readable and writeable non-volatile memory.

According to another embodiment the application circuit 310 comprises a micro controller of the type ATMEL AVR AT 90 S2313.

The application circuit 310 may alternatively comprise a Programmable Logic Circuit (PLC), suitably programmed to perform the functions described in this document. In the PLC embodiment the input port 312 may comprise circuitry for transforming the bit sequence from serial to parallel so as to provide data in a parallel manner to the PLC. Conversely the output port 314 may comprise circuitry for transforming a parallel output from the PLC to a serial bit sequence.

Although the invention has been described with reference to the devices 20 being audio devices, it is to be noted that the improvements described in this document may also find application in other fields. For example, the devices 20 may be lighting or illumination devices, whereby the local controllers 30 control the power to lamps. The devices 20 may alternatively be any other type of device, the power of which is electrically controllable by connection to an application interface circuit 40. Alternatively all the devices, or some of the devices 20, may be equipment whose state is to be monitored.

Alternatively some of the devices 20 are audio devices while some are lighting devices. In this manner the system according to the invention may be used e.g. in connection with musical performances where a large number of audio devices 20 and a number of spot lights 20 are to be controlled.

Embodiments of Communication Based on Retransmission

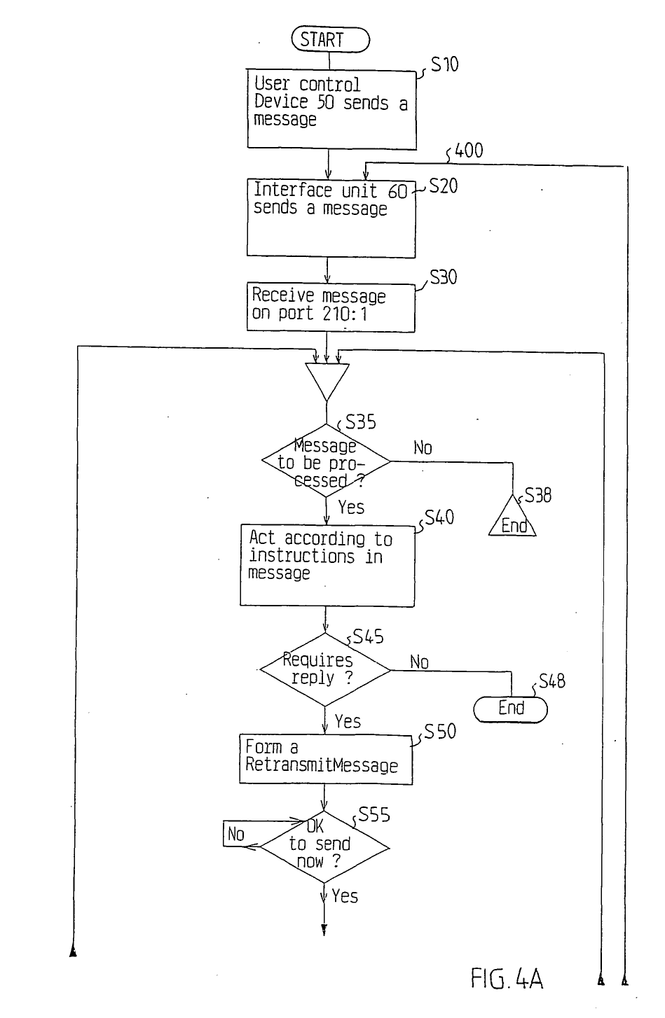

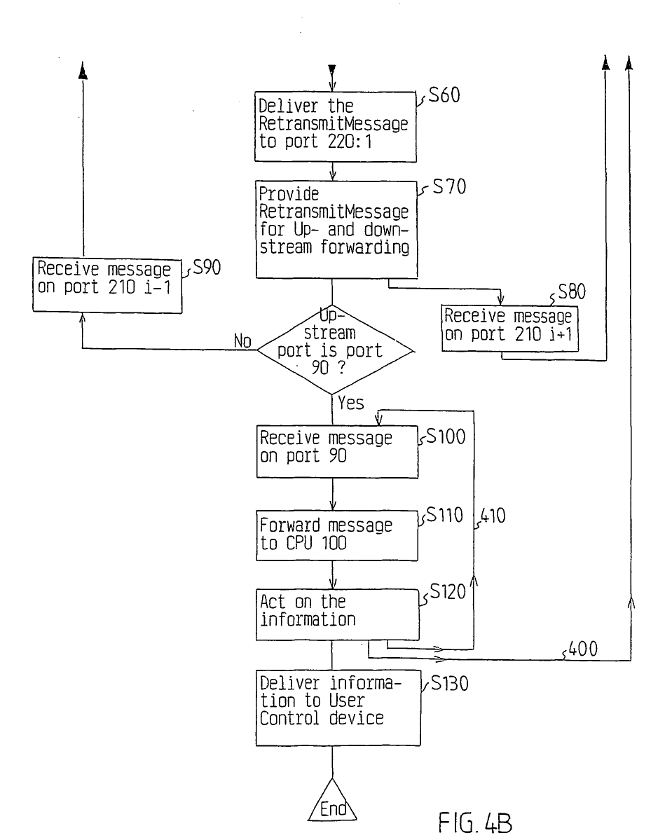

FIGS. 4A and 4B shows a flow chart illustrating an embodiment of a method of operation of the system 10. The system 10 shown in FIG. 1 may start to operate e.g. by power supply being switched on.

In a first step S10 the user control device 50 sends a message via communications path 70 to the interface unit 60. The message may be an instruction, so called token, of type RequestMonitorData, i.e. a request to provide information about the audio devices 20 that are presently attached to the network 10.

The interface unit 60 receives the message on port 80, and operates to transmit a corresponding request on port 90 by means of the CPU output 130 and the amplifier 150, as described above (step S20).

In a step S30 the message from the interface unit 60 is received on port 210:1 (FIG. 1) and delivered to processing unit 350 (FIG. 3) via the circuitry 330 in local controller 30:1. All local controllers 30 follow the same procedure for handling messages. Therefore in the following the description will refer to the local controller by reference 30:i, where i is an integer larger than or equal to one.

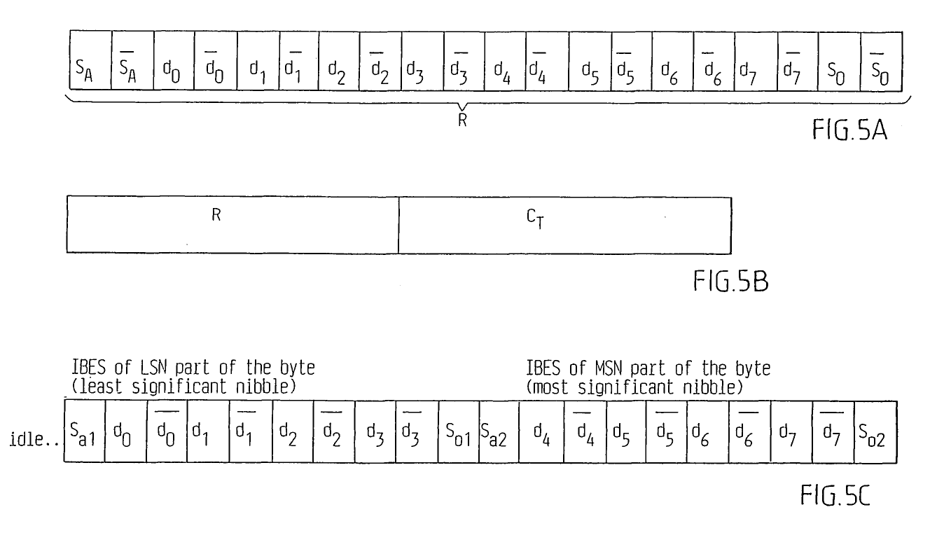

The received message may be temporarily stored in work memory 370. It is to be noted that, due to the function of the communication circuit 300 the message must pass via the application circuit 310 in order to reach the secondary port 220:1, i.e. data does not automatically reach the secondary port 220:1. The application circuit 310:i can therefore perform amendments to information in a received message before delivering it to port 220:i. According to an embodiment of the invention, the amendment can include adding a response bit-stream R as described below in connection with FIG. 5. Such a response bit-stream can include monitoring information which has been fetched from the device 20:i via the application interface circuitry 40:i.

The next step S35 is a test for determining whether this local controller, 30:1, should act on this message. If the test criteria are not fulfilled then this local controller, 30:1, should do nothing at all in response to the message (step S38). If, on the other hand, the test criteria are fulfilled then this local controller, 30:1, should act in accordance with instructions in the message (S40). If the message includes an instruction to control the device 20 the processor 350 sends control data via the application interface circuitry 40 to the device-to-be-controlled 20 (step S40).

As indicated by box S45, step S40 is followed by a decision (S45) as to whether or not the received message requires a reply or retransmission of the message. If the message is an instruction to control the device 20, then such action is completed (S40), and if no reply is requested the procedure is terminated (S48).

If the message, or Control Token Cr, includes a request for reply or retransmission of the message, then step S45 is followed by step S50. “Form a Retransmitt Message”.

An example of a message requiring a reply and a retransmisssion of the message is the Control Token RequestMonitorData. In response to the message type RequestMonitorData the processor 350 reads data via the application interface circuitry 40 (step S40). The processor may also read certain identification data from the non-volatile memory 360, said identification data indicating e.g. what type of audio device this particular local controller 30:1 is attached to. The processor 350 collects the selected data to form a response bit stream R. The response bit stream R may for example be coded in the following manner:

The information to be sent is divided into bytes B_{I}, each byte having eight bits: d0, d1, d2, d3, d4, d5, d6, d7.

According to one embodiment a start bit S_{A} and a stop bit S_{O} are added before and after each byte. This results in ten bits. Thereafter each such ten-bit word is coded with an Inverse Bit Encoding Scheme (IBES). FIG. 5A illustrates the twenty bits resulting from an IBES coding of such a ten bit word according to this embodiment.

The processor 350 forms a RetransmitMessage by adding the bit stream constituting the message, i.e. the control token C_{T}, as received in step S30 to the end of the response information bit stream R (step S50). FIG. 5B illustrates a RetransmitMessage wherein the response information bit stream R is followed by a control token CT. It is to be noted that the IBES-coded bit sequence may include one, several or a large number of information bytes B_{I}.

FIG. 5C illustrates another embodiment of IBES-coded information. As explained above, the information to be sent is divided into bytes B_{I}, each byte having eight bits: d0, d1, d2, d3, d4, d5, d6, d7. According to this embodiment, which may use a standard UART for performing the coding, a byte B₁ is divided into two four-bit nibbles: [d0, d1, d2, d3] and [d4, d5, d6, d7]. Each nibble is then coded as follows: [d0, d0*, d1, d1*, d2, d2*, d3, d3*] and [d4, d4*, d5, d5*, d6, d6*, d7, d7*], where * signifies inverted value. Thereafter, start-bits and stop-bits is added before and after each coded nibble, as illustrated in FIG. 5C. Hence, FIG. 5C illustrates an alternative to the coding illustrated in FIG. 5A.

The control tokens reserved by the protocol are not encoded with IBES, whereas information is coded with IBES. Therefore the local controllers 30 can distinguish between information and control tokens. This, however, puts some restrictions on the bit sequence in control tokens in order to be able to distinguish them from the IBES-coded information. In effect, no token may include a bit combination that could arise from IBES-coding.

In order to distinguish between information and control tokens a local controller 30 will disregard the start and stop bits, and thereafter it will evaluate the information content provided in between the start and stop bits. With reference to FIGS. 5A and 5C, the delivery of four information bits B_{I}, =[d0, d1, d2, d3] requires the actual transmission of eight bits: [d0, d0*, d1, d1*, d2, d2*, d3, d3*]. Because of the Inverse bit encoding, these eight bit words, each of which includes only four bits of information, can only occur in 16 (=2⁴) combinations. These 16 combinations must therefore be excluded from use as control tokens. Since there are 256 possible combinations of an eight bit word, this leaves 256−16=240 combinations for use as control tokens.

Hence, with reference to FIG. 4A, the step S50 will result in a Retransmit message as illustrated in FIG. 5B. At this stage the procedure may include a step S55 for deciding whether or not to send the message. If the test criteria are fulfilled step S55 will be followed by step S60. If the test criteria are not fulfilled no message will be sent.

In a step S60 the RetransmitMessage is delivered on serial output port 314, and forwarded to port 220 by circuitry 340.

From port 220:1 the RetransmitMessage flows downstream towards the next local controller 30:2 via a cable 230 (step S70). The circuitry 320 also provides for the RetransmitMessage to be delivered to port 210:1. Therefore the RetransmitMessage also flows upstream towards the interface unit 60. A box S80 indicating the procedure for the downstream message, and a box S90 indicating the procedure for the upstream message illustrates the fact that the RetansmitMessage is delivered in two directions.

In step S80 the RetransmitMessage is received on port 210:i+1 in the downstream local controller 30:i+1. That local controller now performs the test (step S35) to determine whether the message is to be processed by local controller 30:i+1, i.e. the step S80 is followed by step S35, whereby the above-described procedure is repeated now performed in by local controller 30:i+1.

The RetransmitMessage flowing upstream, i.e. in the direction towards port 90 of the Interface Unit 60, will reach a secondary port 220:i−1, unless the RetransmitMessage was sent from the local controller whose port 210 is directly connected to port 90 (See FIG. 1). In step S90 the RetransmitMessage is received on secondary port 220:i−1, and the circuitry 320 in that communication circuit 300 (FIG. 3) will forward the message to port 210:i−1 in that communication circuit 300. That local controller 30:i+1 now performs the test (step S35) to determine whether the message is to be processed, whereby the above-described procedure is repeated.

When the RetransmitMessage flowing upstream reaches port 90 of the Interface Unit 60, it will be received (step S100) and forwarded to the processing unit 100 (step S110, FIG. 4B and FIG. 2). The Interface Unit 60 will act with the information in accordance instructions in the computer program (step S120). The Interface Unit 60 may for example receive the bit-stream until it detects a control token, while temporarily storing the bit-stream in the work memory 120. The IBES-coded data are decoded and stripped from start bits and stop bits, resulting in one or several information bytes BI. An identity information may be retrieved from the information content, and thereafter the information bytes BI may be stored in a memory segment reserved for information relating to the identified audio device.

Step S120 may be followed by a repetition from step S20, as illustrated by arrow 400 in FIGS. 4A and 4B.

Some control tokens sent by interface unit 60 (step S20) may cause all local controllers to send responses. An example of such a token is RequestMonitorData, causing each connected local controller 30 to respond with a RetransmitMessage comprising an IBES-coded information R followed by a repetition of the token CT, as illustrated in FIG. 5B. This will result in a stream of responses reaching port 90 from the local controllers. Therefore step S120 may be followed by one or several repetitions of steps S100, S110 and S120, as illustrated by arrow 410 in FIG. 4B.

The interface unit 60 may also transmit some or all of the received information to the user control device 50 (FIG. 1) as illustrated by box S130 in FIG. 4B. Step S130 may of course be followed by a new message being sent from the user control device (Step S10).

According to a preferred embodiment the interface unit 60 operates to send a polling message, e.g. RequestMonitorData, with a certain periodicity, regardless of whether the user interface unit 50 requested anything. In this manner the interface unit 60 can keep an updated copy of all information about status of the audio devices in the work memory 120.

An Embodiment of a Transmission Control Procedure

According to one aspect of the invention it is desirable to ensure that not more than one of the local controllers are transmitting at any point in time. There are a plurality of ways possible to achieve this object. One simple embodiment is described here where the system may comprise up to 63 local controllers 30:i, optimized for receiving 4 bytes of information per local controller 16 times per second with a bitrate of 115.2 kbit/s (a standardized bitrate for COM ports on computers).

In this embodiment each local controller 30:i contains a timer. This timer is set to 1/17th of a second upon reset and after each time the controller has transmitted data. While the timer is running the local controller is disabled from communicating. After the timer has timed out it will start to listen on port 210:i, if it hears something that requires a reply it will reply. This leads to the following communication procedure:

S210: The interface unit 60 transmits a message consisting of a control token, CT, at the time t0.

S220: The first local controller 30:1 receives the message (it will not hear it if its timer has not timed out). When the message is complete and the line is idle then 30:1 will send its monitored data followed by CT. 30:1 resets its timer and can disregard the communication for 1/17th of a second.

S230: The second local controller 30:2 receives the information sent by 30:1 (it will not hear it if its timer has not timed out). When the message is complete and the line is idle 30:2 will send its monitored data followed by CT. 30:2 resets its timer and can disregard the communication for 1/17th of a second.

S240: The i:th local controller 30:i receives the information sent by 30:i−1 (it will not hear it if its timer has not timed out). When the message is complete and the line is idle 30:i will send its monitored data followed by CT. 30:i resets its timer and can disregard the communication for 1/17th of a second.

S250: S240 is repeated until i=63.

S260: The procedure S210 to S250 will take less than 1/17th of a second in this embodiment. This means that the interface unit at time t1=t0+1/16th of a second can initiate the procedure S210 to S250 once again.

Using the above procedure interface unit 60 can receive 4 bytes of information from each of the 63 devices 16 times per second.

Sending individual or broadcasted information can be done with a similar procedure, but here the control token, CT, can be accompanied with up to 4 bytes of control information if it's a broadcast or an address byte together with 3 bytes of information if it is a unicast. These limitations in message length are due to the fact that all local controllers must have a mutual idea of how long time it should take for one iteration to be completed. The time it takes for an iteration to be completed must be less than the agreed time, here 1/17th of a second.

Sending a broadcasted command would give the following procedure:

S310: The interface unit 60 transmits a message, M: comprising a control token, CT, stating that it is a broadcast followed by 4 bytes with control data at the time t0.

S320: The first local controller 30:1 receives the message (it will not hear it if its timer has not timed out). When the message is complete and the line is idle 30:1 will interpret M and send M again. 30:1 resets its timer and can disregard the communication for 1/17th of a second.

S330: The second local controller 30:2 receives the information sent by 30:1 (it will not hear it if its timer has not timed out). When the message is complete and the line is idle 30:2 will interpret M and send M again. 30:2 resets its timer and can disregard the communication for 1/17th of a second.

S340: The i:th local controller 30:i receives the information sent by 30:i−1 (it will not hear it if its timer has not timed out). When the message is complete and the line is idle 30:i will interpret M and send M again. 30:i resets its timer and can disregard the communication for 1/17th of a second.

S350: S340 is repeated until i=63.

S360: The procedure S310 to S350 will take less than 1/17th of a second in this embodiment. This means that the interface unit at time t1=t0+1/16th of a second can initiate the sending of a new command (e.g. S210 or S310).

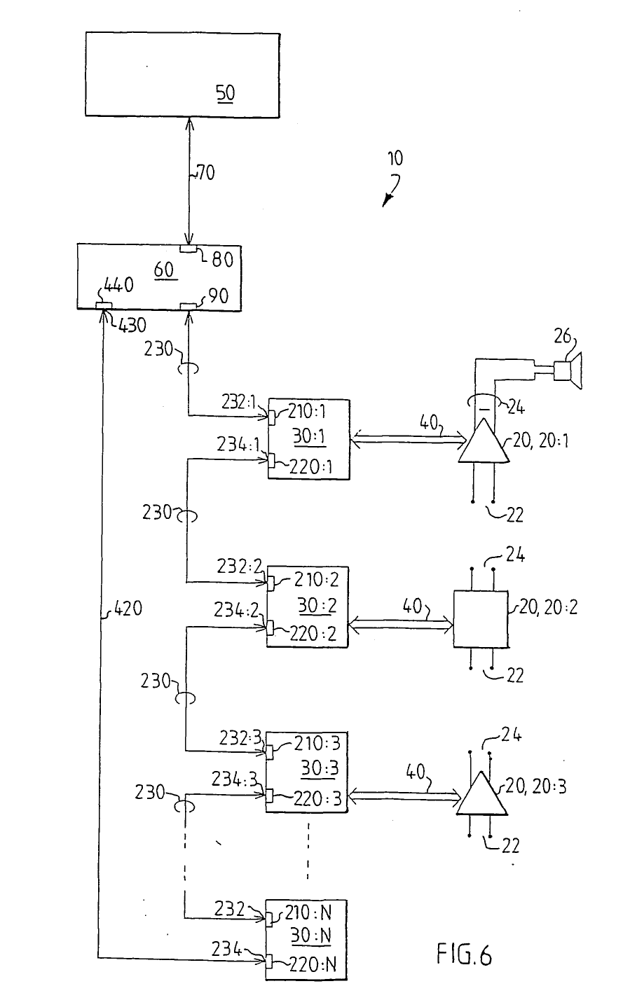

Sending a unicast command, i.e. a message only to one individual local controller 30:2, among a plurality of local controllers connected in chain as illustrated in FIGS. 1 or 6, could be achieved with the following procedure:

S410: The interface unit 60 transmits a message, M, consisting of a control token, CT, stating that it is a unicast followed by an address byte Ab and three bytes of control data at the time t0. In order to reach the second local controller 30:2, as counted in consecutive order from port 90, the adress byte Ab is set to numerical value 2. According to this embodiment all local controllers are set to react on a message including a predetermined address value, e.g. address=zero, and control token to the effect that each local controller is to deduct numerical value one (1) from the received address value. In this manner an individual addressing is achieved, even though each and every local controller operates in identical ways and each local controller reacts to the same address, which may be e.g. numerical value zero (0).

S420: The first local controller 30:1 receives the message (it will not hear it if its timer has not timed out). When the message is complete and the line is idle 30:1 will interpret M and send M again, but with an amended address value. Ab=Ab−1=1. 30:1 resets its timer and can disregard the communication for 1/17th of a second.

S430: The second local controller 30:2 receives the information sent by 30:1 (it will not hear it if its timer has not timed out). When the message is complete and the line is idle 30:2 will interpret M and realize that it is a unicast intended for itself. It will immediately send M again, but with Ab=Ab−1=0. 30:2 resets its timer and can disregard the communication for 1/17th of a second.

S440: The i:th local controller 30:i receives the information sent by 30:i−1 (it will not hear it if its timer has not timed out). When the message is complete and the line is idle 30:i will interpret M, since M is a unicast with Ab=0, meaning that the message was intended for an earlier local controller, it will simply send M again to complete the iteration. 30:i resets its timer and can disregard the communication for 1/17th of a second.

S450: S440 is repeated until i=63.

S460: The procedure S410 to S450 will take less than 1/17th of a second in this embodiment. This means that the interface unit at time t1=t0+1/16th of a second can initiate the sending of a new command (e.g. S210 or S310 or S410).

This solution makes it possible to connect a number of local controllers 30 to an interface unit 60 and start communicating with all of them without needing any unique individual address in any local controller. Moreover, it enables a very user friendly and simple procedure when an error occurs in an audio device so that it has to be replaced. An operator may simply replace the erring audio device 20:2 together with the corresponding local controller 30:2, and insert a new local controller 30:2 with an audio device 20 like the erring audio device. If, for example, an error occurs in the audio device 20:2 (See FIG. 1) an operator may simply disconnect the corresponding connectors 232:2 and 234:2 from the erring device 30, and insert the connectors 232:2 and 234:2 in the replacement device 30. The communication will immediately function in accordance with the procedure according to the invention.

Hence, in the system 10 according to the invention it is not necessary to set addresses in the individual units 20, 30 in order to achieve communication between the user control device and the units 20, 30.

Another Embodiment of a Transmission Control Procedure

Another embodiment of the procedure for ensuring that not more than one of the local controllers transmits information at any point in time requires the inclusion of a status word in the message. This embodiment is described with reference to FIGS. 1 and 4 and Table 1. The example of Table 1 is to be interpreted with the assumption that the there are 4 local controllers 30 connected in the system, i.e. N=4 in FIG. 1.

When the interface unit 60 sends a message it includes a status word S_{W} at a predetermined position within the message. According to one embodiment the status word is a two-bit word positioned at the end of the token. According to this embodiment the interface unit 60 and all local controllers 30 are provided with a predetermined reference word R_{W} to be used at system start-up and after reset. This reference word may be R_{W}=[0, 1].

The first transmission from unit 60 and reception by unit 30:1 is indicated as a Transmission Cycle TC in Table 1. The first message sent by the interface unit 60 at start-up, or after reset, will include a status word S_{W}=[S1, S2]=[0, 1] (cf step S20 in FIG. 4A). This message is illustrated on the first line in Table 1, indicating that unit 60 transmits S_{W}=[0, 1], the internal reference value in unit 60 also being R_{W}=[0, 1].

The second line in the table indicates that unit 30:1 receives the message (compare step S30 in FIG. 4), and identifies the received status word to be S_{W}=[0, 1]. Unit 30:1 compares the received status word with the internal reference value, and finding identity the test result unit 30:1 concludes the test criterion to be fulfilled (indicated by “OK” in Table 1). In response to this test result unit 30:1 will now amend its current internal reference to be RW=[1,0]. According to an embodiment of the invention these are the method steps performed in box S55 in FIG. 4A. This means that it is now OK for unit 30:1 to transmit, i.e. with reference to FIG. 4 the procedure described in figure continues with step S60.

The transmission by unit 30:1 is indicated by step S60 in FIG. 4 and the third line in Table 1. This starts a retransmission cycle RTC1. As indicated in table 1, the retransmitted message is received by units 60 and 30:2, both of which compares the received status word SW to their local references RW=[0,1], finding the test result to be OK.

The next retransmission cycle RTC2 is started when unit 30:2 transmits. When this message is received by unit 30:1 the received status value [0,1] will not correspond to the amended reference which is [1,0]. Hence unit 30:1 will not transmit anything.

In the same manner unit 30:3 and unit 30:4 will cause retransmission cycles RTC3 and RTC4, respectively.

In this manner Unit 60 will receive a stream of information from the attached local controllers 30, until the last one 30:N has sent its message. The interface unit 60 will wait for a predetermined duration to ensure that no more message is coming. If nothing arrives within the predetermined duration then unit 60 will invert the internal reference value, i.e. set it to RW=[1,0], and thereafter send another message. This starts another cycle, indicated by C2 in Table 1. The message will be received by 30:1, and since unit 30:1 has set its internal reference to [1,0] in the previous cycle, the test result for unit 30:12 will again be OK.

An Automatic Addressing Procedure

Using any one of the above described embodiments of communication based on retransmission, the interface unit 60 receives a response from each of the attached local controllers after sending a message on port 90. This is clearly shown by the communication cycle C1 in Table 1. Hence, by counting the number of responses received in response to a message sent on port 90, the interface unit 60 can create an addressing scheme for the local controllers 30. This may be obtained by sending the token RequestMonitorData on port 90, coded so that all connected nodes will receive the message by the retransmission procedure described above. The RequestMonitorData may be sent several times per second, whereby the responses will update the interface unit 60 about the number of attached local controllers 30. In this manner the interface unit 60 will quickly detect any changes of the network.

The interface unit 60 may send a command token “Enumerate” and a reference address, e.g. 64, digitally coded on port 90. The message will be received by 30:1, and in response thereto 30:1 will store the received reference address,i.e. 64 in an address field. Thereafter 30:1 will retransmit the command token “Enumerate” but with an amended reference address value. The retransmitted address value may e.g. be 63, i.e. the received address minus one. In this manner the local controllers will receive addresses 64, 63, 62 etc until the end of the chain. The example presupposes a maximum of 64 local controllers. The method, however may be used in the manner that the interface unit sends reference address one, and each local controller adds 1. Hence, the local controllers would get addresses 1, 2, 3, . . . N, where N is a positive integer.

Once the local controllers have obtained individual addresses it is also possible to provide a direct addressing, as shown below.

Another Embodiment of a Communications System

FIG. 6 shows a block diagram of the control system 10, when an additional communications line 420 connects the N:th local controller directly with the interface unit 60.

The communications line 420 has a connector 232, as described above, for connecting to the port 220 of the N:th local controller 30:N, and a connector 430 for connection to a second port 440 on the interface unit 60 (FIG. 6 and FIG. 2).

The provision of the line 420 enables the interface unit to send a message that will be directly forwarded to all local controllers, since the hardware circuitry 320 in the local controllers (FIG. 3) forwards everything received on port 220.

The line 420 as well as the lines 230 may be embodied by shielded twisted pairs of conductors.

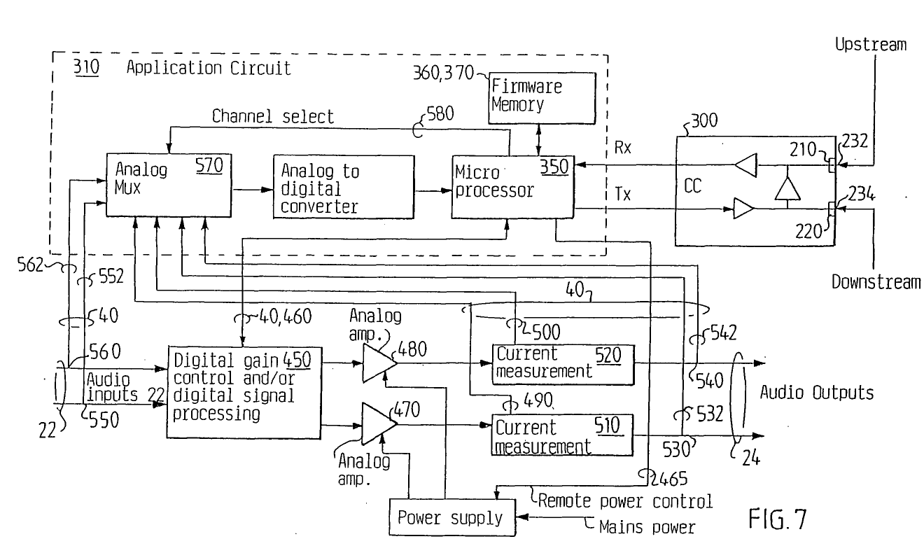

FIG. 7 is a schematic representation of an embodiment of a local controller 30 and a corresponding device 20. The device 20 includes a Digital Signal Processor 450 for processing the audio data received on input 22 in accordance with the control data delivered on a part 460 of application interface circuitry 40. The control line 460 is connected to processor 350 in unit 310. Also connected to processor 350 is a control data line 465 for controlling the power supply to analogue amplifiers 470, 480 in accordance with control data.

The application interface circuitry 40 also includes lines 490, 500, 532, 542, 552, 562 for delivering monitoring data from sensors 510, 520, 530, 540, 550, 560 to a Mux 570. The processor 350 can control the MUX 570 by means of control line 580 to select an analogue signal for reading by processor 350. In this manner the processor 350 can obtain voltage values on the audio inputs and outputs as well as current values, thereby enabling delivery of monitoring information.

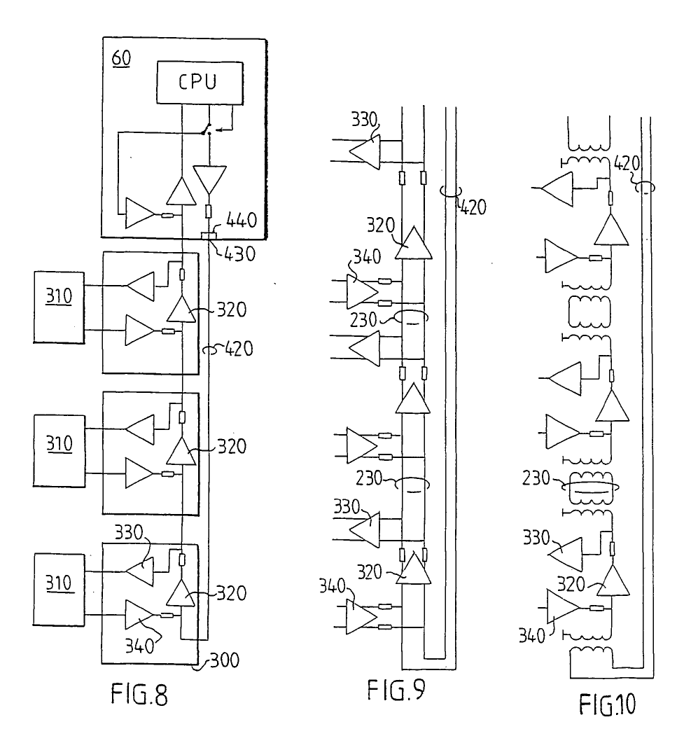

FIGS. 8, 9 and 10 illustrate embodiments of communications circuits 300 functioning as described in connection with FIG. 3

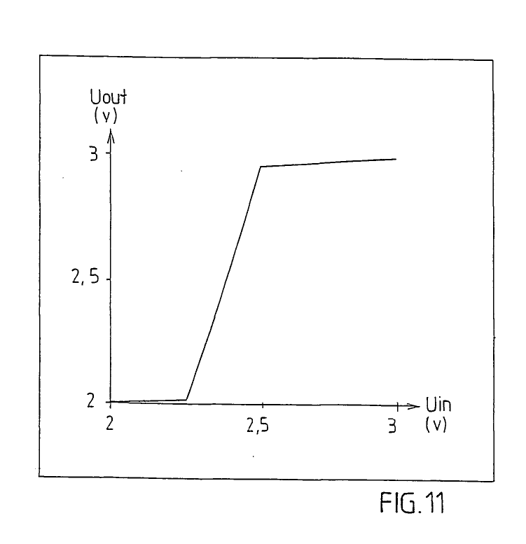

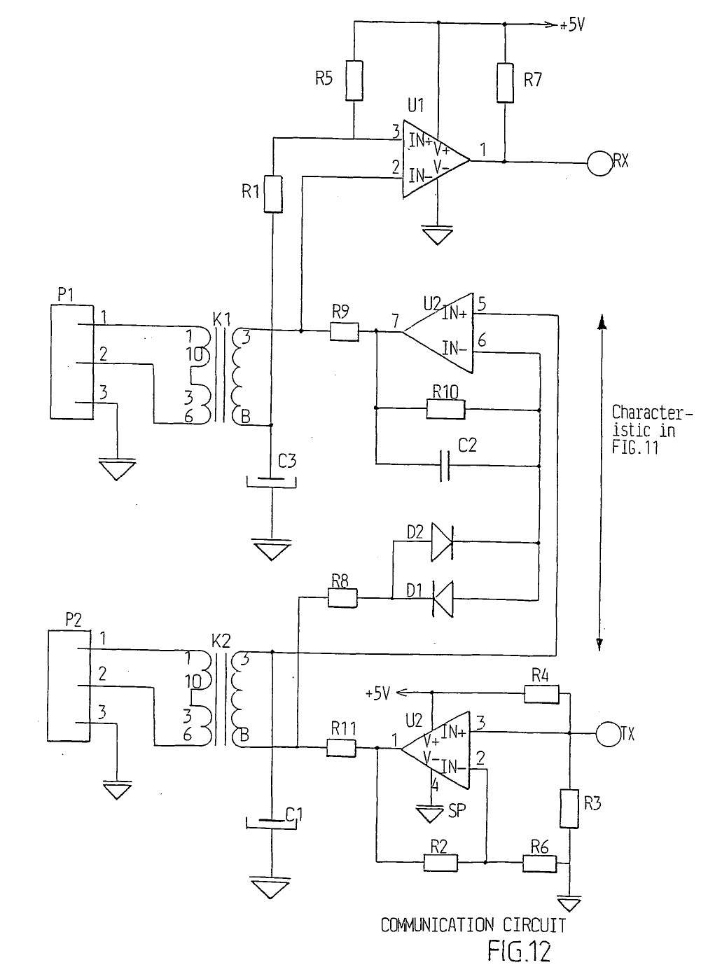

FIG. 11 illustrates an example of the transmission characteristic of the circuitry 320, shown in FIGS. 3, 8, 9, and 10. In order to suppress noise the circuitry 320 will forward only those received signals that have an amplitude above a predetermined limit value.

FIG. 12 is a schematic representation of an embodiment of the communications circuit 300. The transmission characteristic illustrated by FIG. 11 is obtained with an embodiment of the circuitry 320. An embodiment of such circuitry is shown in FIG. 12.

1. An audio system comprising:
at least one audio device having
at least one audio signal input (22),
at least one audio signal output (24),
at least one audio device control port (40), and
circuitry for modifying an audio signal; said signal modification
circuitry being connected to the at least one audio signal input (22) and
to the at least one audio signal output (24);
a central controller (50) having
a user interface for allowing a user to monitor and/or control the audio system;
a central control port for communication via a first communications path (70);
an interface unit (60) having
a first interface port (80) for communication with said central controller (50) via said first communications path (70);
a second interface port (90); and
means (110, 120, 130, 140, 150, 160, 170, 100) for delivering and/or receiving a message on said second interface port (90);
a first local controller (30, 30:1, 30:2, 30:i) having
a device port coupled to said audio device control port,
a primary local port (210, 210:1, 210:2, 210:i) coupled to the second
interface port (90) of said interface unit (60), and
a secondary local port (220, 220:1, 220:2, 220:i);
wherein the first local controller (30, 30:1, 30:2, 30:i) comprises
means (330, 312, 350, 360, 370) for receiving a message arriving on the primary local port (210, 210:1, 210:2, 210:i), and means (350, 360, 370, S55) for determining permission to transmit a message; and
means (314, 340, 350, 360, 370) for transmitting a message on the secondary local port (220, 220:1, 220:2, 220:i) when permitted to do so.

2. The system according to claim 1, wherein the local controller further comprises
means for receiving a message arriving on the secondary local port and means for transparently forwarding such a message for delivery on the primary local port.

3. The system according to claim 1, further comprising a second local controller having
a device port for coupling to a further audio device control port,
a second primary local port coupled to the secondary local port of said first local controller.

4. A first local controller (30) having
a device port (40) coupled to a device control port for communicating with a device to be monitored and/or controlled,
a primary local port (210, 210:1, 210:2) for coupling to a first interface port (90) of an interface unit;
a secondary local port (220, 220:1, 220:2);
means for receiving a message arriving on the primary local port (210, 210:1, 210:2);
means for setting a first address value when said received message includes an instruction to set an address;
means for storing said first address in an address field of said first local controller (30);
means for generating a second address value in response to said instruction to set an address; said second address value being different from said first address value;
means for determining permission to transmit a message; and
means for transmitting a message on the secondary local port responsive to said permission determining means; wherein
said transmitted message, in response to said instruction to set an address, includes said generated address value and said instruction to set an address.

5. A local controller (30) having
a device port (40) coupled to a device control port for communicating with a device to be monitored and/or controlled,
a primary local port (210, 210:1, 210:2) for coupling to a first interface port (90) of an interface unit, and
a secondary local port (220, 220:1, 220:2).

6. The local controller according to claim 5, further comprising:
means for receiving a message arriving on the primary local port, and means for determining permission to transmit a message; and
means for transmitting a message on the secondary local port when permitted to do so.

7. The local controller according to claim 5 or 6, further comprising:
means for setting a first address value when said received message includes an instruction to set an address;
means for storing said first address in an address field of said first local controller (30);
means for generating a second address value in response to said instruction to set an address; said second address value being different from said first address value; wherein
said transmitted message, in response to said instruction to set an address, includes said generated address value and said instruction to set an address.

8. The local controller according to claim 4, 5, 6 or 7, further comprising:
means (320) operating to detect data being received on the secondary communications port (220), said data detection means (320) also operating to transfer such data to said primary port (210).

9. The local controller according to claim 8, wherein
said data detection means (320) is adapted to transfer said data substantially without latency and/or substantially without delay.

10. The local controller according to any one of claims 4 to 9, wherein said means for determining permission to transmit a message includes:
a reference word (R_{W}) stored in said local controller (30);
means for extracting a status word (S_{W}) from a received message;
means for comparing said received status word (S_{W}) with said reference word (R_{W});
means adapted to permit transmission of a message in response to the outcome of said comparison.

11. The local controller according to claim 10, wherein said means for determining permission to transmit a message includes:
means for amending said reference word (R_{W}) stored in said local controller (30) in response to said comparison having an outcome permitting transmission of a message.

12. A method of operating the controller according to claim 5, the method comprising:
receiving a message arriving on the primary local port,
determining permission to transmit a message; and
transmitting a message on the secondary local port when permitted to do so.

13. The method according to claim 12, further comprising:
receiving a message on the secondary local port;
transparently forwarding the message from the secondary local port for delivery on the primary local port.

14. The method according to claim 13, wherein said message is forwarded substantially without latency and/or substantially without delay.

15. The method according to claim 12, 13 or 14, further comprising:
setting a first address value when said received message includes an instruction to set an address;
storing said first address in an address field of said first local controller (30);
generating a second address value in response to said instruction to set an address; said second address value being different from said first address value; and
including said generated address value and said instruction to set an address in said transmitted message when said received message includes an instruction to set an address.

16. The method according to claim 12, 13, 14 or 15, wherein said step of determining permission to transmit a message includes:
comparing a status word (S_{W}) derived from a received message with a reference word (R_{W}) stored in said local controller (30); and
permitting transmission of a message in response to an outcome of said comparison.

17. The method according to claim 12, 13, 14, 15 or 16, wherein said step of determining permission to transmit a message includes:
amending said reference word (R_{W}) stored in said local controller (30) in response to said comparison having an outcome permitting transmission of a message.

18. A communications system comprising:
an interface unit (60) having
a first interface port (80);
a second interface port (90); and
means (110, 120, 130, 140, 150, 160, 170, 100) for delivering and/or
receiving a message on said second interface port (90); and
at least one local controller (30) according to any of claims 4 to 11.

19. The communications system according to claim 18, further comprising:
at least one device (20) to be monitored or controlled.

20. The communications system according to claim 19, wherein:
said at least one device (20) is connectable to a local controller (30) for delivering data to and/or receiving data from said at least one local controller (30).

21. The communications system according to claim 19 or 20, wherein:
said at least one device (20) includes a device for generating light.

22. The communications system according to claim 19, 20 or 21, wherein said at least one device (20) includes at least one audio device having
at least one audio signal input (22),
at least one audio signal output (24),
at least one audio device control port (40), and
circuitry for modifying an audio signal; said signal modification
circuitry being connected to the at least one audio signal input (22) and to the at least one audio signal output (24).

23. The communications system according to claim 22, wherein
said at least one audio signal input (22) is adapted for receiving a digital or analogue signal; and
said at least one audio signal output (24) is adapted for delivering a digital or analogue signal.

24. The communications system according to any of claims 18-23, wherein
said interface unit (60) has a second port (440);
the secondary local port (220, 220:N) of one of said local controllers (30:N) is connected to second port (440) of said interface unit (60).

25. The communications system according to any of claims 18-23, wherein
said interface unit (60) has a second port (440); wherein system comprises:
a plurality of local controllers (30, 30:1, 30:2, 30:3, 30:N) being connected in a chain, wherein the primary local port (210:1) of a first local controller (30:1) is connected to a first interface port (90) of said interface unit 60); and
the secondary local port (220:1) of said first local controller (30:1) is connected to the primary local port (210:2, 210:i, 210:N) of an other local controller (30:N); and
the secondary local port (220:N) of a local controller (30:N) is connected to second port (440) of said interface unit (60).

26. The communications system according to claim 25, wherein said plurality of local controllers (30, 30:1, 30:2, 30:3, 30:N) includes up to sixty-four local controllers (30, 30:1, 30:2, 30:3, 30:N) connected in a chain.

27. The communications system according to any of claims 18-23, wherein
a connection between two local controllers (30, 30:1, 30:2, 30:3, 30:N) is embodied by a shielded twisted pair of conductors, and/or where a connection between a local controller (30, 30:1, 30:2, 30:3, 30:N) and said interface unit (60) is embodied by a shielded twisted pair of conductors.

28. An interface unit for co-operation with a plurality of local controllers according to claim 4 or 5.

29. A computer program for performing the method according to any of claims 12-17 when said computer program runs on a computer unit (100) in said local controller (30).

30. A computer program product comprising:
a computer readable medium, having thereon a computer program according to claim 29.
